(19) United States
(12) Patent Application Publication
(10) Pub. No.: US 2017/0064980 A1
(43) Pub. Date: Mar. 9, 2017

(54) PORTABLE LAWN CLIPPING SILAGE PROCESSING METHOD

(71) Applicant: Todd Michael Graus, Jackson Hole, WY (US)

(72) Inventor: Todd Michael Graus, Jackson Hole, WY (US)

(21) Appl. No.: 15/257,039

(22) Filed: Sep. 6, 2016

Related U.S. Application Data
(60) Provisional application No. 62/213,712, filed on Sep. 3, 2015.

(51) Int. Cl. A23K 30/12; B65B 63/02; B65B 5/06; B30B 9/06; B30B 15/26

(52) U.S. Cl. CPC A23K 30/12; B30B 9/06; B30B 15/26; B65B 5/061; B65B 63/022

(57) ABSTRACT

The present disclosure is directed to a process utilizing a compaction device that allows for preparing turf lawn clippings for ensiling. The lawn clippings are compacted using the compaction device at or near their source prior to the lawn clippings souring allowing preservation of the clippings. The lawn clippings are compacted to reduce an initial moisture content to a second lower moisture content suitable for ensiling.

### CROSS REFERENCE

The present application claims the benefit of the filing date of U.S. Provisional Application No. 62/213,712 having a filing date of Sep. 3, 2015, the entire contents of which is incorporated herein by reference.

### FIELD

The present disclosure is directed to a method of processing silage for animal fodder. More specifically, the present disclosure is directed to a method of processing turf lawn clippings into silage.

### BACKGROUND

By some estimates, there are between 20 million and 35 million acres of turf or lawn grass in the United States. This means lawns, including residential, commercial lawn, golf courses, playing fields, etc. could be considered one of the largest irrigated crops in the United States by surface area. Moreover, these lawns are mowed (i.e., harvested) multiple times each season, often weekly or even bi-weekly. The resulting volume of lawn clippings creates a disposal problem for municipalities. Along these lines, many municipalities have banned lawn clippings from landfills due to space constraints, encouraged residents to compost lawn clippings and/or encourages use of mulching mowers to reduce disposal volumes.

Use of lawn clippings as animal fodder has previously been explored. However, concerns about pesticides applied to lawns had made many in agriculture leery of utilizing this source of animal fodder. Further, during the late spring, summer and early fall months, when most lawn clippings are available, animals are typically on pasture land do not require supplemental fodder, which could be provided by lawn clippings. Accordingly, any attempt to utilize lawn clippings as animal fodder would require storing the lawn clippings for later use.

A number of issues make storage of lawn clippings for later use impractical. Chief among these issues is that lawn clippings are collected in small batches and often from geographically diverse locations. Furthermore, lawn clippings when bagged or placed in a pile typically begin the composting process within hours of being cut. At the simplest level, the process of composting begins by making a heap of wetted organic matter known as green waste and waiting for the materials to break down into humus after a period of weeks or months. While the composting process results in humus after period of weeks or months, lawn clippings often begin the composing process and rot or ‘sour’ within hours of being cut. Once soured, such clippings are only useful for compost. Animals will not consume soured lawn clippings.

The rapid souring of lawn clippings has made use of standard techniques to preserve grass unsuccessful. For instance, grasses are often baled into hay. Grasses cut for hay are left in the field wilt/dry down via windrowing and turning over the windrows until the grass moisture content falls into the range of 15%-20%. Once dried to the correct moisture range, the dried grasses are baled. Unlike lawn clippings, grasses cut for hay have longer and thicker stem lengths allowing these grasses to dry while piled. The short length of lawn clippings makes baling these clippings impractical even if they could be dried. Further, lawn clippings are removed when they are cut; leaving such lawn clippings on a mowed field to wilt/dry is impractical.

Another process for preserving grass is silage. Silage is fermented, high-moisture stored fodder which can be fed to ruminants (cud-chewing animals such as cattle and sheep) or used as a biofuel feedstock for anaerobic digesters. It is fermented and stored in a process called ensiling and is usually made from crops, including long stem grasses, maize, sorghum or other cereals, using the entire green plant (not just the grain) with the resulting product if processed correctly called silage. Silage is typically made either by placing cut vegetation, which has been allowed to partially dry or wilt, into a silo or by piling it in a large heap and compressing the biomass with heavy tractors and covering the resulting pile with plastic sheeting. It can also be stuffed into a 100-500′ continuous plastic tube or packed in a pit and covered with plastic sheeting.

Once placed in storage, the raw components of silage undergoes anaerobic fermentation, which starts about 48 hours after the silo, pile, pit or tube heap is filled, and converts sugars to acids. Fermentation is essentially complete after about two weeks-three months. Before anaerobic fermentation starts, there is an aerobic phase in which the trapped oxygen is consumed. The closeness with which the fodder is packed, determines the nature of the resulting silage by regulating the chemical reactions that occur in the stack. When too closely packed, the supply of oxygen is limited; and the attendant acid fermentation brings about the decomposition of carbohydrates. This product is named sour silage. If, on the other hand, the fodder is unchaffed and loosely packed, or the packed biomass is built gradually, oxidation proceeds more rapidly and the temperature rises; if the biomass reaches temperatures above 100° F. could reduce the fermentation quality, enhance protein degradation, and reduce the rapid pH decline necessary for an efficient fermentation. Excessively heated or heat-damaged silages have a brown to dark brown color with a tobacco-type smell. Part of the protein in “heat-damaged” silages is complexed with carbohydrates and is less digestible. The concentration of heat-damaged protein depends on both the temperature and the length of time the temperature is elevated. “Heat-damaged” silage may be palatable, but part of the protein and some of the energy it contains will be unavailable to livestock. A temperature of more than 20° F. above the air temperature when the forage was ensiled indicates poor fermentation and excessive dry matter losses. When silage temperatures exceed 130° F. the resulting product may become unpalatable and potentially toxic as an animal feed. Attempts to preserve lawn clippings using standard silage techniques (e.g., silo/heap) have been unsuccessful resulting in the creation of compost rather than silage.

### SUMMARY

Aspects of the presented inventions are based on the realization that a large unutilized source of fodder, lawn clippings, is available for animal feed if these clippings could be preserved for later use. The presented inventions are directed to apparatuses and processes (i.e. utilities) for preserving lawn clippings via an ensiling process. The utilities include preparing and packaging lawn clippings/cuttings by implementing the use of a typically portable processing device that produces a compressed biomass of lawn clippings, which are suitable for ensiling. The compression of the lawn clippings rapidly reduces a moisture level of the lawn clippings to an allowable level for ensiling. Further, such compression reduces available oxygen within the compressed lawn clippings. In combination, the reduction of moisture and reduction in available oxygen stops or delays the composting process which has previously prevented successful ensiling of lawn clippings.

In one aspect, it is been recognized that by compacting lawn grass clippings to a moisture range between about 50% and about 70% psi, more preferably in a narrow range between about 59% and 65% allows successful ensiling of lawn grass clippings. When the compression is excessive, too much moisture/water is pressed out of the biomass and, if the biomass is left with less than 50% moisture content, molds and mycotoxins are produced. Too little water is left to carry out the ensiling process. If the compression force is too little, excessive air and air pockets lead to degraded nutrient value, toxic compounds can form and in extreme situations, spontaneous combustion can occur.

The grass clipping are compacted in a compacting device that is configured to apply high pressures to grass clippings placed therein. Such compression, typically ranges from about 7 pounds per square inch (psi) and about 15 psi to produce the desired moisture levels. More preferably, the range is between 8 psi and 12 psi with an currently believed target of 9 psi. Once a mass of lawn grass clippings are compressed to a desired moisture level, forming a compacted loaf, the compacted loaf of clippings may be removed from the compactor. Typically the loaf of clippings is placed in a substantially impermeable liner. Once disposed within the substantially impermeable liner, the liner is closed (e.g., sealed) such that the oxygen uptake rate of the compacted loaf of clippings is significantly limited. At this time, the trapped oxygen is consumed and the anaerobic silage process begins.

The compacted clippings are typically places in an impermeable container with a low rate of oxygen transfer. OTR (oxygen transmission rate) is the steady state rate at which oxygen gas permeates through a membrane at specified conditions of temperature and relative humidity. Value are expressed in cc/100 in²/24 hr in US standard units and cc/m²/24 hr in metric units. Standard test conditions are 73° F. (23° C.) and 0% RH. More specifically, the compacted clippings or loaf are removed from the compacting device and displaced into a, for example, a poly liner having an oxygen transfer rate (OTR) of no more than 100 cc/100 in²/24 hr. More preferably, the OTR should be no more than 80 cc/100 in²/24 hr, Yet more preferably less than 85 cc/100 in²/24 hr and even yet more preferably less than 78 cc/100 in²/24 hr.

Though the size of the compacting device may be varied, is preferably size that is easily portable and provides bails the compacted clippings in a size that is commonly utilized for animal fodder. In one arrangement, the compacting device generates bales that are scalable but most efficiently used at the 2000 pounds size.

### DESCRIPTION OF THE FIGURES

FIG. 1 illustrates a perspective view of a compacting device.

FIG. 2 illustrates a partially exploded view of the compacting device.

FIGS. 3-5 illustrate simplified side view illustrating the operation of the compacting device.

FIGS. 6A-6D illustrate using a compacting device to bag compressed lawn clippings.

FIG. 7 illustrates variation in the cutting of crass clippings.

FIG. 8 illustrates a perspective view of another embodiment of a compacting device.

FIG. 9 illustrates an ensiling process for lawn clippings.

### DESCRIPTION

Reference will now be made to the accompanying figures, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

The presented disclosure is directed to a process that facilitates a fermentation process called ensiling utilizing high moisture content vegetation. More specifically, the present disclosure is directed to a process utilizing a compaction device that allows for preparing turf lawn clippings for ensiling. The lawn clippings are compacted using the compaction device at or near their source prior to the lawn clippings souring allowing preservation of the clippings. In this regard, lawn clippings may be placed into the compacting device shortly after they are cut/mowed/harvested (e.g., on-site such as a residential driveway, commercial parking lot, golf course fairway, sod growing field, etc.). The compacting device compresses the clippings.

Compression shortly after mowing (e.g., on-site or remotely) provides two important benefits for the lawn clippings. First, such compression reduces the moisture content of the clippings. Lawn clippings initially have a moisture content of over 75% and typically in the range of 80-85% or higher if mowed during or shortly after precipitation. This high moisture content accelerates the souring process of the clippings when bagged or piled, which prevents successfully ensiling the clippings. By compacting, moisture may be removed (i.e. squeezed out) from the compacted clippings. Second, compression reduces the oxygen content within the compacted clippings reducing the possibility of the biomass reaching temperature in excess of 20° F. above ambient air temperatures or temperatures above 130 F.°. That is, as the space between individual fibers is compacted, air is expelled from the compacted clippings. Both water removal and air/oxygen removal from the compacted clippings allow the clippings to sit for hours or even days without souring. In this regard, such compacted clippings may now be fermented (ensiled) and utilized as animal feed.

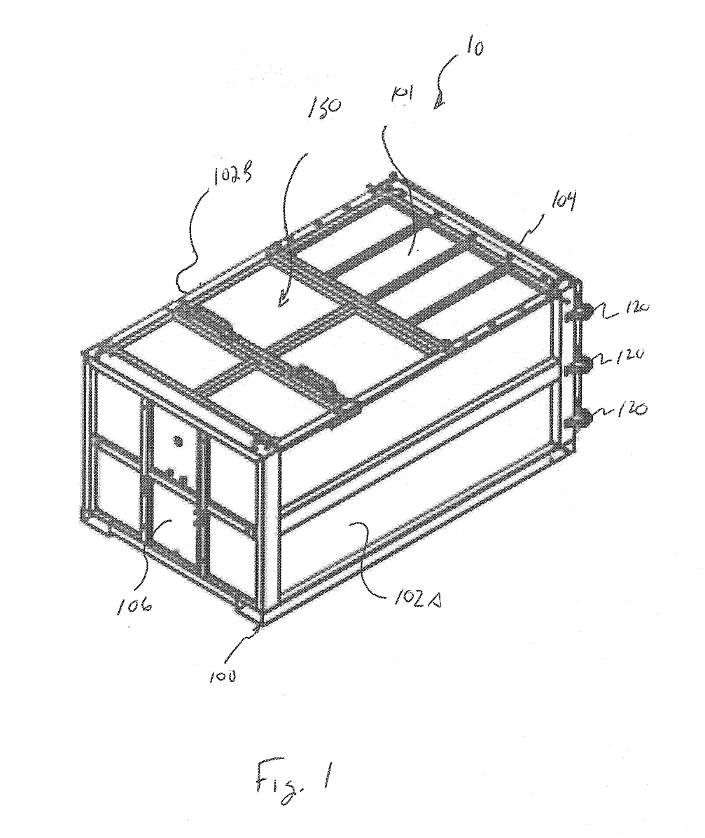

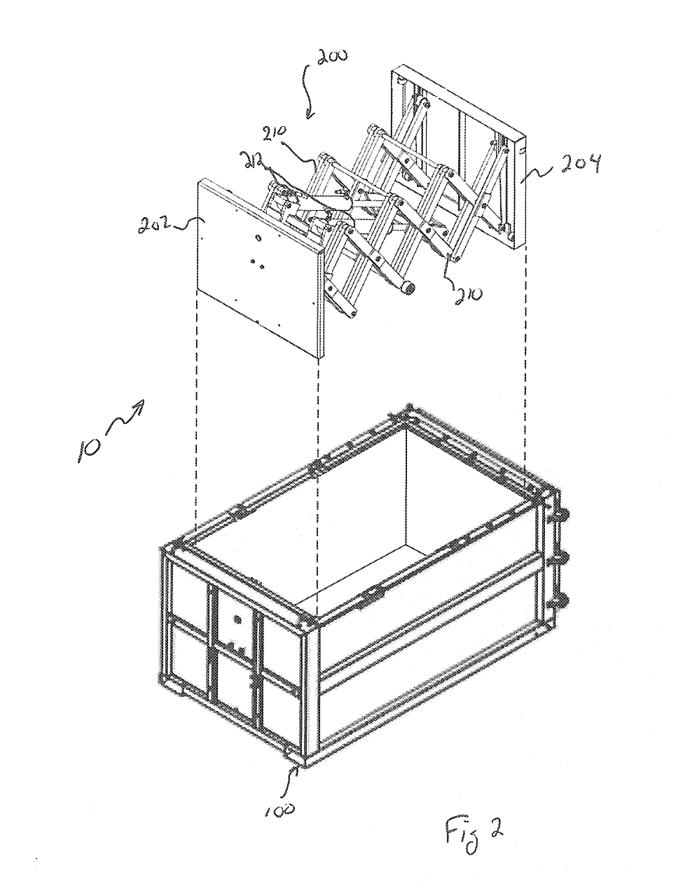

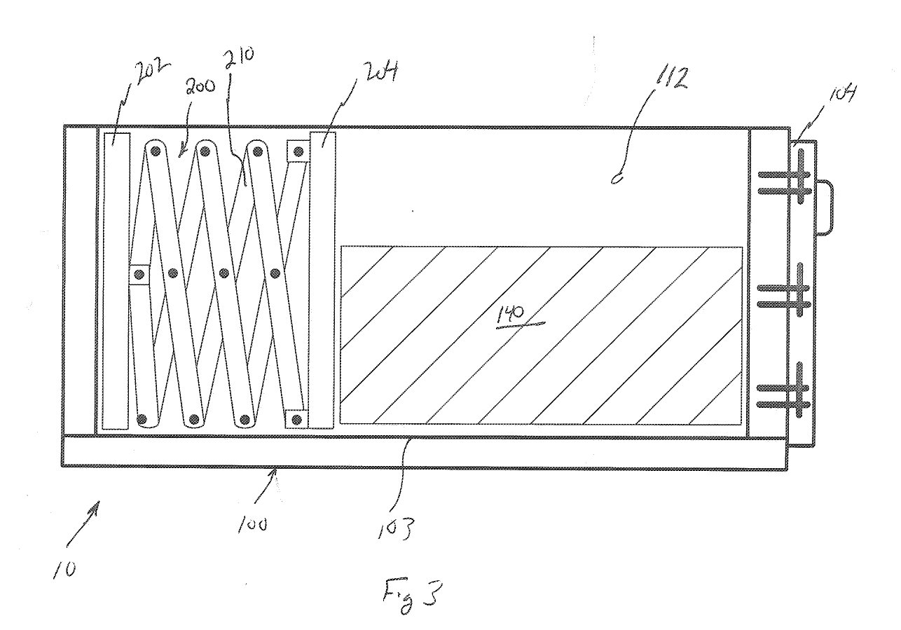

Referring to FIGS. 1 and 2, one non-limiting embodiment of a compacting device 10 for use in compacting lawn clippings is depicted. It will be appreciated the disclosed process many use any compacting device that provides a desired level of compaction for lawn clipping and the illustrated embodiment is provided for purposes of discussion and not by way of limitation. The compacting device 10 is formed as a generally rectangular box 100, extending from a gate 104 to a closed second end 106, with two opposite side walls 102A and 102B, a bottom wall 103 and a top wall 101. Internally, the box 100 has a compaction chamber defined by the inside surfaces of the walls, the gate 104 and a compaction plate 204 of a hydraulic compactor 200. A hinged lid 152 in the top wall 101 allows biomass such as lawn clippings to be placed in the compaction chamber 112 between the compaction plate 204 and the inside surface of the gate 104. See, e.g., FIG. 3. Hinges 120 mount the gate to the box 100 allowing the gate 104 to move from a closed position to an open position. A latch (not shown) maintains the gate in the closed position during compaction. The box 100 is generally manufactured from high strength materials such as steels and aluminums. Additionally, various reinforcing struts may be incorporated to increase the strength of the box.

The hydraulic compactor 200 fits within the interior of the box 100 and has a base plate 202 that is juxtaposed against the inside surface of the closed second end 106 of the box. Alternatively, the inside surface of the closed second end of the box may form the base plate. In the illustrated embodiment, a pair of rhombus or scissor linkages 210 extend between the base plate 202 and the compaction plate 204. The scissor linkages 210 allow controlled expansion and contraction between the plates 202, 204. More specifically, in the illustrated embodiment, a pair of hydraulic cylinders 212 are connected to the scissor linkages 210 to control the expansion and contraction between the plates. The hydraulic cylinders 212 may be attached to any appropriate hydraulic source. In any case, hydraulic cylinders 212 are sized in conjunction with the area of the compaction plate 204 to provide a desired level of compaction pressure to lawn clippings or other biomass disposed within the compaction chamber.

It will be appreciated that the box 100 of the compacting device 10 may be constructed of a suitable size to allow placement or mounting within the bed of a pick-up truck. In other installations, such a system could be mounted on a flatbed truck, on a trailer for towing landscaping equipment, or placed in a fixed location (as for example an equipment shed at a golf course). Stated otherwise, the compacting device may be constructed such that is easily transportable. Such portability has significant benefit in the present application where the device is used to compact lawn clippings which are often harvested at different locations.

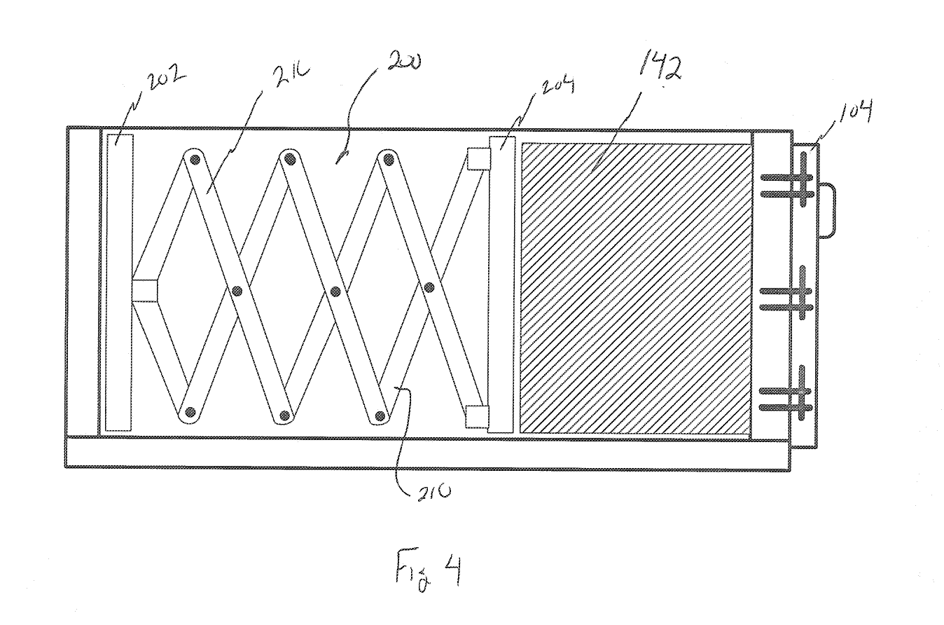

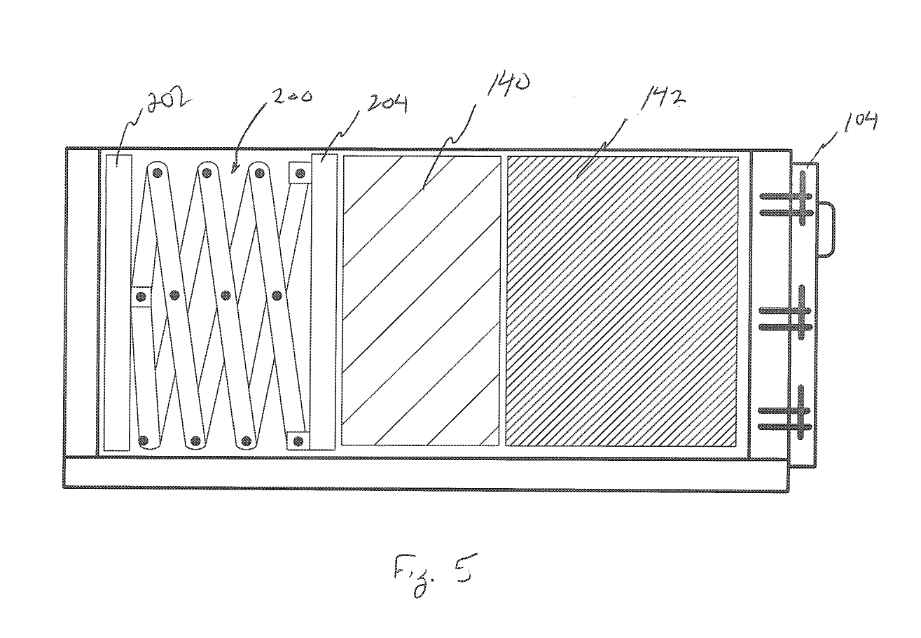

FIGS. 3-5 illustrate a simplified side view of the compaction device 10 in operation. Sidewall 102A is removed for purposes of illustration. Initially, loose lawn clippings 140 are disposed within the compaction chamber 112 between the compaction plate 204 of the hydraulic compactor 200 and the closed gate 104. See FIG. 3. Once filled to desired volume, the hydraulic cylinders (not shown) expand the scissor linkages 210 to push the compaction plate 204 toward the closed gate 104 compacting the loose lawn clippings 140 into a compressed mass or loaf 142. See FIG. 4. As will be appreciated, this process may be repeated. That is, once grass clippings within the device 10 are compacted into the loaf 142, the compaction plate 204 may be retracted to allow loading additional loose lawn clippings 140 into the device 10. See FIG. 5. Along these lines, a user may move the compacting device to a different location between compaction cycles. Further, the compacting device 10 may maintain the compacted loaf 142 of lawn clippings in a compressed state between compaction cycles to maintain low oxygen levels within the clippings and thereby impede or prevent composting process. Typically it is desirable that the compressed lawn clippings remain under a load between cycles to continue the exclusion of oxygen within the compaction chamber of the particular “flake” of compressed clippings where a sum of multiple compaction cycles and flakes form the loaf. Further, time is required to expel moisture and air from the inner most regions of the loaf. The moisture and air is restricted by the available outlets (e.g., apertures in the bottom wall for water) where moisture and air is allowed to escape. The overall capacity in pounds of the loaf in directly related to the lack of pore space/compression. The less pore space or air pockets there are, the more clippings that can be added equaling a target maximum packaged weight.

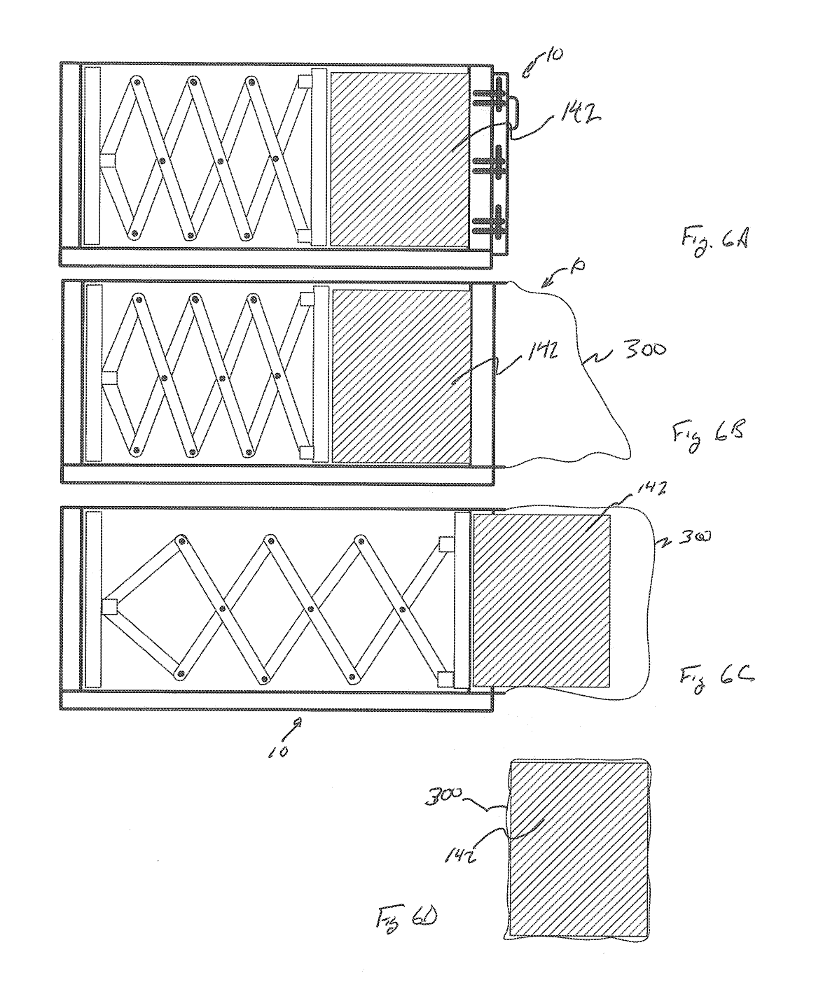

While the clippings remain viable while under pressure within the compacting device, such pressurized storage is infeasible for long-term storage. Accordingly, it is been recognized that once compacted to reduce moisture content of the clippings to a desired level and reduce the air/oxygen within the compacted clippings, the compacted clippings may be bagged to initiate the ensiling process. FIGS. 6A-6D illustrate the process of unloading the compaction device after lawn clippings are compressed to a desired level. More specifically, 6A illustrates lawn clippings compressed into a loaf 142 in accordance with the parameters discussed herein. Once properly compressed, the gate 104 is opened (not shown in FIGS. 6B and 6C for purposes of illustration) and a substantially impermeable bag 300 may be attached about the opening of the gate. See FIG. 6B. At this time, the hydraulic compactor 200 expands to displace the loaf 142 out of the box 10 and into the bag 300. See FIG. 6C. Once the loaf 142 is disposed within the bag 300, the bag is closed around the loaf 142 substantially sealing the loaf therein. Any appropriate means of closing the bag may be utilized including zip ties, cable ties, air lock configurations, heat sealing etc. In any case, once bag is closed, airflow into and out of the bag and the enclosed loaf 142 is substantially reduced though it need not be entirely eliminated. Further, when compacted in accordance with parameters discussed herein, the enclosed loaf 140 ensiles permitting long-term storage of the loaf and its subsequent use as animal fodder.

The substantially impermeable bag 300 should significantly limit exchange of air between the loaf and ambient air. It is currently believed that such a bag preferably have an oxygen transfer rate (OTR) of less than 90 cc/100 in²/24 hours. More preferably, the OTR should be no more than 80 cc/100 in²/24 hours, and yet more preferably less than 85 cc/100 in²/24 hours and even yet more preferably less than 78 cc/100 in²/24 hour. Such impermeability allows more readily achieving an anaerobic state suitable for ensiling lawn clippings.

In a first ensiling phase, or initial aerobic phase, oxygen entrapped within the compressed loaf results, due to respiration of the compressed clippings and microorganisms therein, in the production of water and carbon dioxide until oxygen is restricted and depleted.

In the compressed loaf, compression can significantly exceed compression of a biomass that uses its own weight (e.g., heap or silo ensiling) resulting in a rapid decline in pH which minimizes dry matter (DM) losses. During a second ensiling phase or main fermentation phase, oxygen has been depleted, but pH is still relatively high allowing spoilage microorganisms to grow. Lactic acid bacteria proliferate and consume plant carbohydrates to produce lactic acid (strong acid), which decreases the biomass pH below a critical point inhibiting or killing spoilage microorganisms. During a third ensiling phase or stable phase, lactic acid bacteria are dominant and lactic acid becomes the predominant end product formed. During the stable phase, the lawn clipping become silage, which may be stored for significant time periods (months or even years). Utilizing the disclosed process, the rapid reduction of pH allows the ensiling process to occur in a reduced time period. The ensiling process may be completed in as little as three weeks to one month.

Aspects of the present disclosure are based on the realization by the inventor that lawn clippings have unique qualities that have previously prevented successful ensiling of the same. Ensiling of agricultural crops is done with crops harvested at much taller heights than lawn grass. Agricultural crops are harvested at between about 14 inches, in the case of alfalfa, and about 7 feet or more, in the case of corn. The longer agricultural crops include significant stem or stalk portions that typically have a much lower moisture content than leaves and meristem plant tissue. More importantly, the stem or stalk portions of such agricultural crops allow cut crops to partially dry or wilt in the field (e.g., in windrows in the case of alfalfa) prior to being compacted in an ensiling process. That is, once cut, agricultural crops may lay in the field where airflow may readily flow through the crops due to the long stalks/stems that provide porosity the cut and piled crops. In the case of corn, the corn plant may remain unharvested until the corn plants dry to a desired level; the plants are wilted prior to harvesting. Regardless, wilting of the plant tissue is necessary to lower moisture to a level that permits ensiling.

In the case of lawn clippings, mowers will typically chop a three to six inch tall grass blade several times reducing it to between ¼ inch to 2 inches overall length. This is contrast to agricultural grasses that are swathed and typically cut once near the base of the stem. Further, lawn clipping are comprised almost entirely of meristem tissue having an extremely high moisture content, typically between about 80% and 85% or higher. To make silage from lawn grass clippings using prior art would require a mowing company to mow one day, leave the clippings spread on the lawn surface, return when the clippings are wilted to a desired moisture level and collect (e.g., rake, vacuum, etc.) the wilted clippings. Such a process is impractical from both cost and aesthetic standpoints. Further, if the grass clippings were collected and left to dry in a pile, the time required to wilt to a desired moisture level of, for example 65%, would typically take over 24 hours. This is an unachievable task as the composting process begins as quickly as four hours after harvesting with the onset of the mesophilic heating stage, which is the first stage of the composting process. Stated otherwise, due to the high moisture content of the lawn clippings and their small size, piled or bagged clippings prevent any significant airflow through the amassed clippings. Rather than drying, the clippings begin to mold or sour.

The inventor has further recognized that an alternative to wilting lawn clippings is to reduce the moisture level via compression. The process allows reducing the moisture level of freshly harvested grass clippings from 80-85% or higher to, for example, 65% shortly after harvesting. The reduction of the moisture level via compression circumvents the wilting process previously required. Further, the compression of the grass clippings eliminates oxygen within the amassed clippings which allows for the subsequent packaging of the lawn clippings without mold production or inadvertently making compost. That is, lawn clippings that compost often grow various molds or funguses that may be life threating to livestock. Such fungal pathogens include Aspergillus fumigatus, Candida albicans, Candida vaginitis, certain species of Fusarium, and others. Aspergillus fumigatus is known to cause mycotic pneumonia, mastitis, and abortions in cattle and has been recently proposed as the pathogenic agent associated with mycotic hemorrhagic bowel syndrome (HBS) in dairy cattle.

A further recognition relating to the successful ensiling of lawn clippings is that lawn clippings require a narrow moisture band to safely ensile. Through experimentation, it has been determined that after 30 day of ensiling in a substantially impermeable bag as discussed above, molds or toxins occur if a moisture level is too high at the beginning of the ensiling process and also occur is a moisture level is too low at the beginning of the ensiling process. In one example, clostridium botulinum was observed in lawn clipping silage when moisture within the bag exceeded 66%. In another example, aspergillus was observed in lawn clipping silage when the moisture content of the bag fell below 58%. Thus it has been determined that an allowable moisture range for lawn clipping bagged in a substantially impermeable bag to produce silage is between 59% and 65%. Thus, it is desirable to control the compacting device to produce a desired moisture level in the compressed clippings loaf.

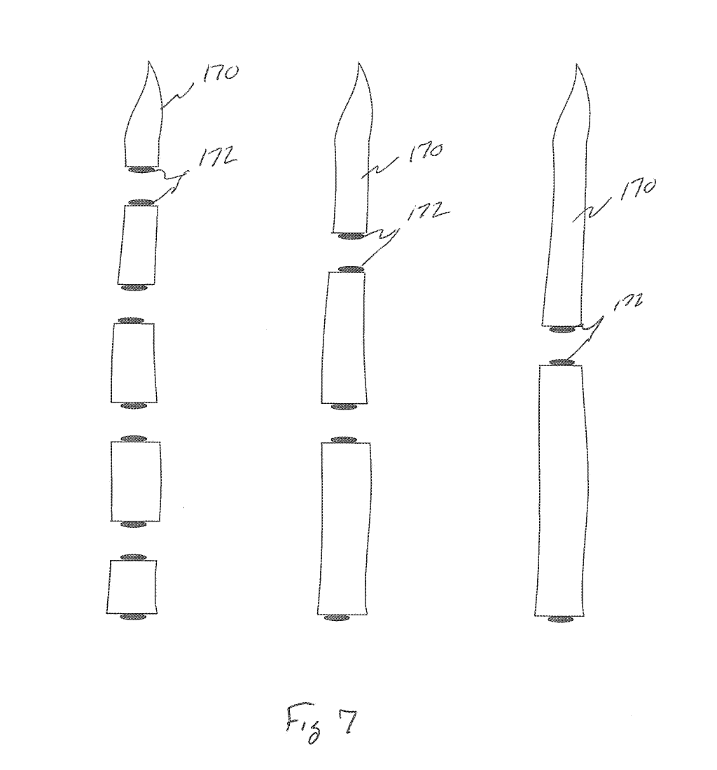

The nature of lawn clippings complicates the determination of a compression level necessary to achieve a desired moisture level in a compressed loaf of lawn clippings. As noted above, lawn clippings are typically cut multiple times when mowed. This is illustrated in FIG. 7. As shown, individual lawn grass blades 170 having a common length may be cut a different number of times (e.g., depending on the mower utilized). Each cut of a lawn grass blade 170 allows droplets of water 172 to more freely exit the grass blade via enhanced guttation (i.e., the secretion of water from plant pores). Cutting the lawn grass blades more times (e.g., shorter clippings) frees more water from the grass blades. This is one reason that piled grass clippings sour, the amount of free water in a pile of clippings prevents air flow through the pile. In any case, less compression force is required to reduce the initial moisture level of shorter lawn clippings to a desired level as more of the water in the clipping is freed. Conversely, cutting lawn grass blades fewer times (e.g., longer clippings) frees less water requiring higher compression forces to reduce the initial moisture level. By way of example, if lawn grass clippings were swathed (e.g., cut once) they would require significantly greater compression to reduce moisture levels than lawn grass clippings that were cut multiple times. Accordingly, it has been recognized that it is necessary to control compaction of lawn grass clippings based on a moisture level after compaction rather than on a simple compaction pressure.

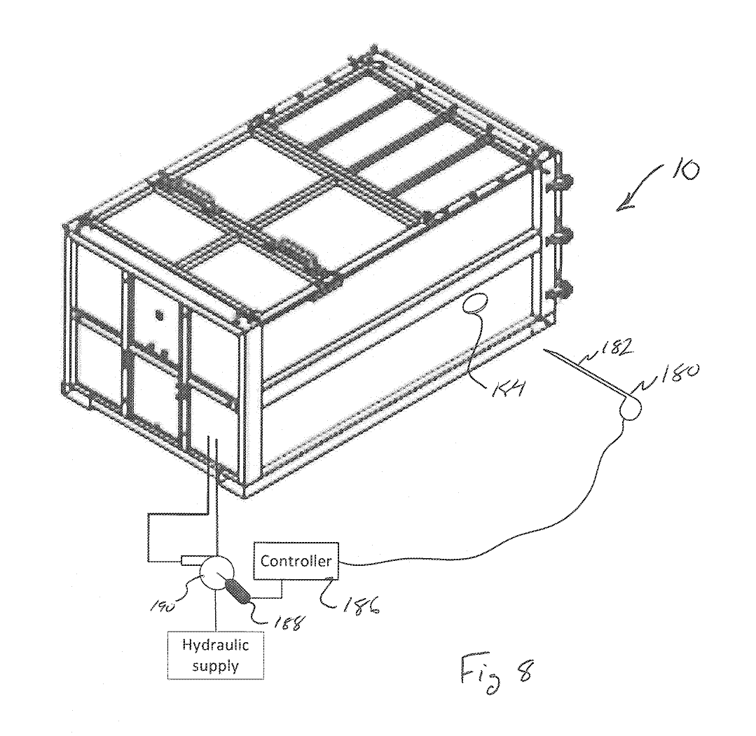

FIG. 8 illustrates one embodiment of a compacting device 10 that allows for compacting lawn grass clippings based on moisture levels of the compacted clippings. As shown, the compacting device 10 incorporates a moisture meter 180 having an elongated spear or probe 182 that may be disposed through an aperture 184 within a sidewall of the compacting device 10. The moisture meter 180 allows for determining the moisture within grass clippings in the compacting chamber of the device 10. Such moisture meters are known in the prior art and are commercially available. After compacting the clippings, a user may insert the elongated probe 182 through the aperture to determine the moisture level of the loaf of lawn clippings within the compaction chamber. It will be appreciated that such measurement may be performed a predetermined time after compaction to allow for water compressed out of the compacted lawn clippings to drain through bottom of the device 10. This latter regard, the bottom wall and/or lower edges of the sidewalls of the device may include apertures (not shown) at permit water to drain from the device 10. In its simplest form, use of such a moisture meter allows a user to manually control the hydraulic compactor (not shown) within the device 10.

In another embodiment, the moisture meter 180 is operatively connected to a controller 186, which controls the operation of the hydraulic compactor or other compacting mechanism. In one embodiment, the controller 186 is connected to an electronic motor 188 that operates a hydraulic pump 190 which supplies hydraulic fluid to the hydraulic cylinders of the compactor. Though illustrated externally to the device, it will be appreciated that the pump, motor and/or controller may be incorporated or housed within the device 10. In such an arrangement, a space may exist between the base plate of the compactor and the closed end wall of the box. The controller may, for example, after initial compaction automatically increase the compaction force of the compactor to achieve the desired moisture level in the compacted clippings. That is, the controller may be programmed to take a moisture measurement from the moisture meter 180 after initial compaction. Then, after predetermined time, the controller 186 may take a second measurement to determine if a desired moisture level exists within the compacted clippings. If the moisture level is too high, the controller may automatically increase the compaction force of the compactor. Such a process may be repeated until a desired moisture level is achieved. In such an embodiment, an initial compaction force may be low enough to assure the grass clippings are not over compressed resulting in a moisture level that is too low. Though illustrated as utilizing a manually inserted moisture probe, it will be appreciated that insertion of such a probe may be automated.

It will be further appreciated that after moisture measurements are obtained for lawn clippings, operation of the compacting device may be performed on a compression force basis. For instance, a landscaping company may mow a common type of turf for lawn grass (e.g., Kentucky bluegrass) and know the average initial moisture level of the grass (i.e., which may change with the seasons, precipitation etc.) and/or an average clipping length of the lawn clippings they produce. Of note, a bag of cut lawn grass clippings will typically include clippings of varying lengths. However, such law grass clippings do have an average length allowing the user to assume that subsequent clippings made by the same mower(s) will have a similar average clipping length. Accordingly, such users may, based on prior compaction moisture levels and force levels for similar clippings (e.g., initial moisture levels, clipping length, etc.) set their compacting devices to a predetermined compaction force to achieve a desired moisture level. In this regard, moisture measurement for each compaction is not strictly required. Further, it will be appreciated that such information may be tabulated for use manually and/or with an automated system where user inputs one or more parameters.

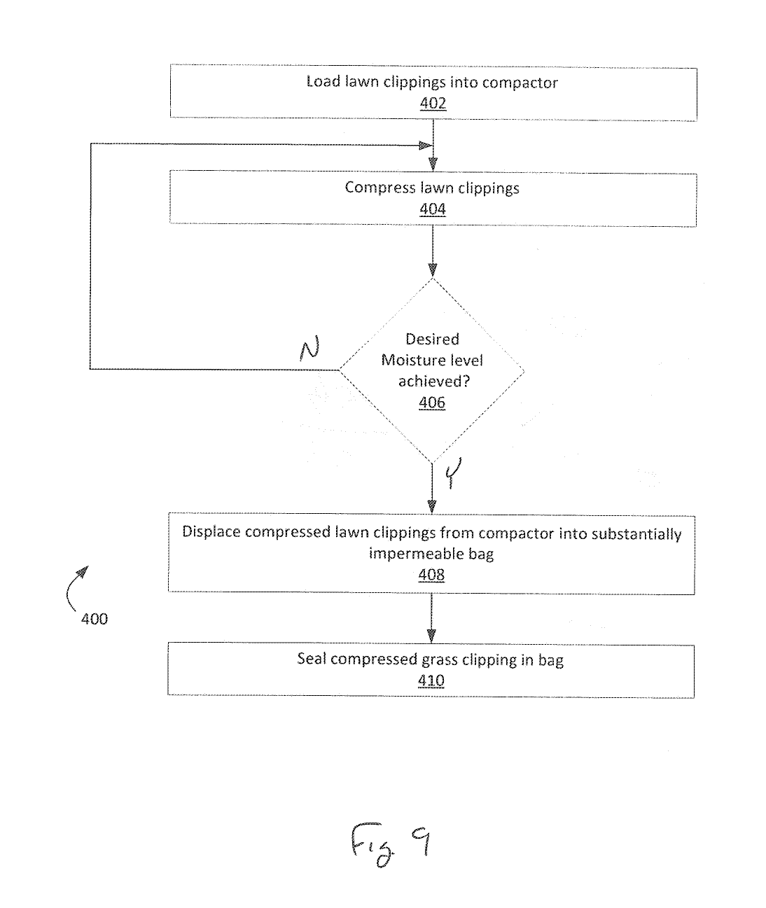

FIG. 9 illustrates a process flow sheet for the overall process disclosed herein. The process 400 includes loading 402 loose lawn clippings into a compactor. As noted above, the exact configuration of the compactor may be varied so long as compactor provides adequate compression force for the lawn clippings. Once loaded into the compactor, the lawn clippings are compressed 404. Optionally, the moisture level may be measured 406 after initial compression to determine if the desired moisture level is achieved. As set forth above, such moisture levels may include an upper moisture level as well as lower moisture level (i.e., desired moisture band). If a desired moisture level is not achieved, the lawn clippings may be re-compressed 404. Alternatively, if parameters of the lawn clippings are known (e.g., average clipping length, initial moisture level, etc.) the lawn clippings may be compressed to a desired compression level associated with the moisture level for the known parameters of the lawn clippings. Once a desired moisture level is achieved within the compressed lawn clippings, the compressed loaf of lawn clippings may be displaced from the compactor into a substantially impermeable bag 408. Once disposed within the bag, the loaf of lawn clippings may be enclosed therein 410 to begin the ensiling process.

### EXAMPLE

The following examples are directed to compression of Kentucky Bluegrass having an initial moisture level between 80% and 85% with an average clipping length of about between 1 and 2 inches. The compressions were performed in a compactor that produces a compressed loaf with dimensions of 42″×32″×55″ (73,920 sq. inch) resulting in a loaf that is approximately 2000 pounds or a density of approximately 43 lbs per cubic foot.

Compacting the grass clippings to a moisture level between 50% and 70% corresponded with an applied force of between about 7 pounds per square inch (psi) and about 15 psi. Based on the size of the compaction plate (42″×32″) this equated to a compression force of between about 9400 lbf and about 20,000 lbf. It was found that the 50% moisture level left the loaf of lawn clippings with too little water to carry out the ensiling process. It was also found that the 70% moisture level left the loaf of lawn clippings with excess water resulting in clostridium botulinum growth. Further experimentation resulted in determining that a moisture range of between 59% and 65% produced high quality silage. The 59% moisture level corresponded to approximately 11,000 lbf or approximately 8.25 psi. The 65% moisture level corresponded to approximately 12,200 lbf or approximately 9.1 psi. Once compacted within these ranges, the moisture and oxygen content within the compressed clippings is acceptable for the ensiling process. Further, these results allow for compression of lawn clippings based on force measurement for identical or similar grass clippings.

The presented process provides a number of benefits. Perhaps foremost, the process allows use of a wasted resource for animal fodder. Along these lines, the process allows for recapturing or reclaiming irrigation water that is tied up in lawn clippings at harvesting. Further, a number of studies have shown that the ensiling process breaks down most common herbicides more quickly removing these herbicides from the environment and providing a safe animal fodder.

The presented process also increases the number of sources of animal fodder. Previously, only those in agricultural related careers (farmer, ranchers) having cropland and/or a rural setting could process and store ensilage. The present disclosure allows individuals in careers in landscaping, horticulture and/or forestry, among others, to produce ensilage by harvesting lawn clippings and/or tree leaves in an urban setting since the system may be portable. For instance, the presented process allows a lawn mowing company to deposit their collected clippings directly into a compactor device that can compress the lawn clippings at the multiple locations where they are mowing. The compressed clippings within the compactor can then be packaged at the landscapers office at the end of the day and enclosed bags can then be transported to storage and/or and end use location.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

1. A process for making silage from lawn clippings, comprising:
loading a mass of loose lawn clippings into a compaction chamber of a compacting device, wherein the loose lawn clippings have a first moisture level;
compacting the loose lawn clippings into a compacted mass of lawn clippings, wherein water is compressed out of the compacted mass of lawn clippings until the compacted mass of lawn clippings has a predetermined second moisture level that is lower than said first moisture level;
displacing the compacted mass of lawn clippings out of the compacting device; and
enclosing the compacted mass of lawn clippings in a substantially impermeable enclosure.

2. The process of claim 1, wherein said first moisture level is above 80%.

3. The process of claim 2, wherein said second moisture level is below 70%.

4. The process of claim 3, wherein said second moisture level is in a range between 59% and 65%.

5. The process of claim 2, wherein loading the mass of loose lawn clippings comprises:
loading loose lawn clippings having an average length of less than six inches.

6. The process of claim 5, wherein said average length is less than three inches.

7. The process of claim 1, further comprising:
obtaining an indication of said first moisture level; and
controlling said compacting of the mass of loose lawn clippings based at least in part on said indication of said first moisture level to achieve said second moisture level.

8. The process of claim 1, further comprising:
obtaining an indication of a moisture in the compacted mass of lawn clippings; and
based on said indication in the compacted mass of lawn clipping, further compressing the compacted mass of lawn clippings to achieve said second predetermined moisture level.

9. The process of claim 8, further comprising:
obtaining said indication of moisture from a moisture probe inserted into the compacted mass of lawn clippings.

10. The process of claim 8, wherein a controller operatively connected to said compacting device receives said indication and adjusts a compaction force of the compacting device.

11. The process of claim 1, further comprising:
inputting at least one parameter associated with the loose lawn clippings into a controller operatively connected to said compacting device;
wherein said controller controls a compaction force of the compacting device based on said at least one parameter.

12. The process of claim 11, wherein said at least one parameter comprises:
said first moisture level;
an average length of the loose lawn clippings; and
said second moisture level.

13. The process of claim 1, wherein said compacting device applies a compacting force to said lawn clippings in a range between 7 pounds per square inch (psi) and 15 psi.

14. The process of claim 13, wherein said range is between 8 psi and 10 psi.

15. The process of claim 1, wherein said enclosing the compacted mass of lawn clippings in said substantially impermeable enclosure further comprises:
enclosing the compacted mass of lawn clippings within a substantially permeable bag having a oxygen transfer rate (OTR) of less than 100 cc/100 in²/day;

16. The process of claim 1, wherein said second moisture level of the compacted mass of lawn clippings is achieved by application of a predetermined force applied by the compacting device, wherein said predetermined force is correlated to at least a first parameter of the loose lawn clippings.

17. A process for making silage from lawn clippings, comprising:
loading a mass of loose lawn clippings into a compaction chamber of a compacting device, wherein the loose lawn clippings have an initial moisture level above 80% and an average length of less than 3 inches;
compacting the loose lawn clippings into a compacted mass of lawn clippings having a moisture level of between 50% and 70%;
displacing the compacted mass of lawn clippings out of the compacting device; and
enclosing the compacted mass of lawn clippings in a substantially impermeable bag having an oxygen transfer rate of less than 100 cc/100 in²/day.

18. The process of claim 17, wherein compacting comprises:
compacting the compacted mass of lawn clippings to moisture range of between 59% and 65%.

19. A compacting device for compacting lawn grass to produce silage, comprising:
a compaction chamber configured to receive loose lawn clippings;
a compaction plate movable between a first location and a second location within the compaction chamber;
an actuator for moving said compaction plate between the first location and the second location;
a moisture probe configured for selective insertion into said compaction chamber and operative to output a moisture signal corresponding to a moisture level of lawn clipping in said compaction chamber; and
a controller operatively connected to said actuator and said moisture probe, wherein said controller is configured to operate said actuator to move said compaction plate in response to said moisture signal.

20. The compacting device of claim 20, wherein said actuator comprises at least one hydraulic cylinder.
